(19) United States
(12) Patent Application Publication
(10) Pub. No.: US 2012/0126971 A1
(43) Pub. Date: May 24, 2012

(54) Anti-Theft Wind Generator Security Cage for Air Condition/Heat Pump Condenser

(76) Inventor: James E. Robinson, JR., Columbia, SC (US)

(21) Appl. No.: 13/220,661

(22) Filed: Aug. 29, 2011

Related U.S. Application Data
(60) Provisional application No. 61/466,826, filed on Mar. 23, 2011.

(51) Int. Cl. G08B 1/08; G08B 21/00; H02K 7/18; B65D 85/00

(52) U.S. Cl. 340/539.11; 206/321; 340/540; 290/52

(57) ABSTRACT

The invention is an environmentally friendly anti-theft security cage for outdoor air conditioner/heat pump units conceived to prevent the vandalism and theft of copper tubing from the unit and to recycle energy waste from the units protected. In addition to protecting the units from vandalism, the security cage is equipped with wind-powered generator(s) positioned to utilize the exhaust from the enclosed air conditioner/heat pump units to generate electricity. Single or multiple generators may be utilized dependent upon the capacity and number of air conditioner/heat pump units enclosed. The cage is also equipped with anti-tamper sensors connected to a microprocessor to provide an alarm system to discourage thieves.

### CROSS-REFERENCE TO RELATED APPLICATIONS

Provisional application No. 61/466,826

Filing Date: Mar. 23, 2011

Relationship: Provisional application was for the same invention, filed by the inventor

### STATEMENT REGARDING FEDERALLY SPONSORED RESEARCH OR DEVELOPMENT

This invention was not made by an agency of the United States Government nor under a contract with an agency of the United States Government.

### REFERENCE TO SEQUENCE LISTING

Not Applicable

### BACKGROUND OF THE INVENTION

This invention serves the dual purpose of providing security for air conditioner/heat pump units and utilizing the exhaust gas from those units to generate electricity. The containment cage with its lockable door, anti-tamper sensor and alarm system provides the security while the wind turbine utilizes the exhaust of the protected air conditioner/heat pump unit to produce electricity.

The invention was the subject of Provisional patent application No. 61/466,826 filed by the inventor, James E. Robinson Jr.

### BRIEF SUMMARY OF THE INVENTION

The invention consists of a containment structure (security cage) used to enclose air conditioner/heat pump unit(s), anti-theft tamper sensors connected to a microprocessor and alarm system, and wind powered generator(s). The size and configuration of the security cage will vary depending on the size and number of air conditioner/heat pump units to be protected, as will the size and number of wind powered generators. The security cage may be constructed of metal or organic polymer composite material.

Air conditioner/heat pump units are often vandalized for the purpose of removal of the copper tubing contained within, a valuable commodity. This results in the release of Freon to the atmosphere, an undesirable detriment to the environment. The cage and security system deter the vandalism of the units.

A wind powered electric generator in the interior of the security cage is position such that it utilizes the exhaust from the protected air conditioner/heat pump unit to generate electricity. The wind turbine is secured by supports affixing it to the interior of the security cage. The electricity generated by the wind powered generator can be used to assist in providing power to the air conditioner/heat pump unit protected, the building serviced by the unit or fed back into the energy grid.

The invention can be utilized in a number of geometries and configurations. A single family residence would typically have a single security cage and generator. An apartment, commercial or industrial building with large or multiple cooling systems may have a single large cage with multiple generators.

### BRIEF DESCRIPTION OF THE SEVERAL VIEWS OF THE DRAWING

FIG. 1 depicts a security cage with single wind powered generator. In this configuration, the security cage is constructed of four (4) side panels (A) with a top panel (B). The panels consist of bars arranged inside a frame to allow for the free flow of air through the cage. Although the arrangement of the bars in the drawing is shown as a cross-diagonal, the configuration of the bars is not limited to that geometry. Support braces (C) are utilized to attach the wind powered generator (D) to the security cage. The wind powered generator would be positioned above the air conditioner/heat pump unit so as to utilize the exhaust from the unit. A door (E) is provided to allow access for maintenance.

FIG. 2 depicts a security cage with single wind powered generator not totally assembled. When fully assembled, the security cage would be constructed of four (4) side panels (A) with a top panel (B). The panels consist of bars arranged inside a frame to allow for the free flow of air through the cage. Although the arrangement of the bars in the drawing is shown as a cross-diagonal, the configuration of the bars is not limited to that geometry. Support braces (C) are utilized to attach the wind powered generator (D) to the security cage. A door (E) is provided to allow access for maintenance.

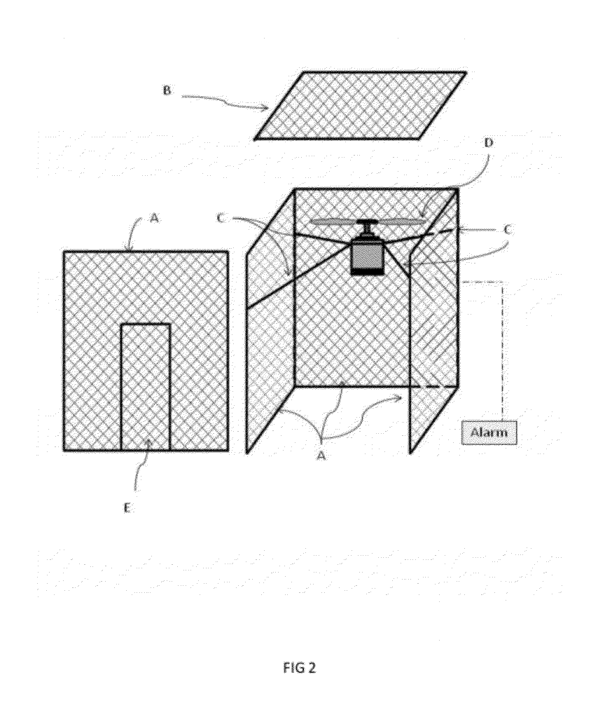

FIG. 3 depicts a security cage with multiple wind powered generators (D). In this drawing, only a portion of the side panels (A) and wind generator supports (C) are shown.

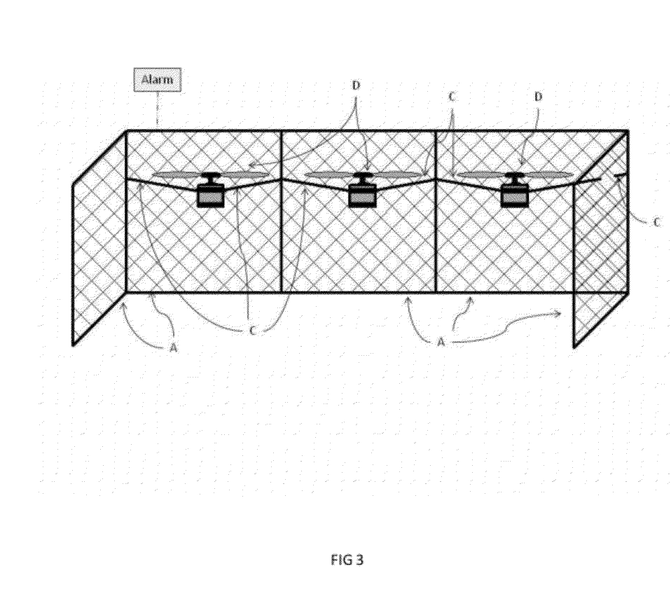

### DETAILED DESCRIPTION OF THE INVENTION

The invention is comprised of three major parts (1) a containment structure (security cage) sized to enclose a single or multiple outdoor air conditioner/heat pump condenser units; (2) an alarm system to alert when an attempt is made to breach the security cage; and (3) a wind-powered generator to produce electricity utilizing the exhaust of the air conditioner/heat pump condenser. There may be multiple wind-powered generators depending on the number of air conditioner/heat pump condenser units enclosed by the security cage or the number of exhausts of a single large protected unit. The size of the wind powered generator may vary depending upon the size of the protected air conditioner/heat pump condenser unit.

The security cage may be constructed in various configurations as is needed to surround the air conditioner/heat pump condenser unit(s). The air conditioner/heat pump condenser unit(s) would thus be contained inside the security cage. The security cage is equipped with lockable door(s) to provide access to the air conditioner/heat pump unit(s) for maintenance purposes.

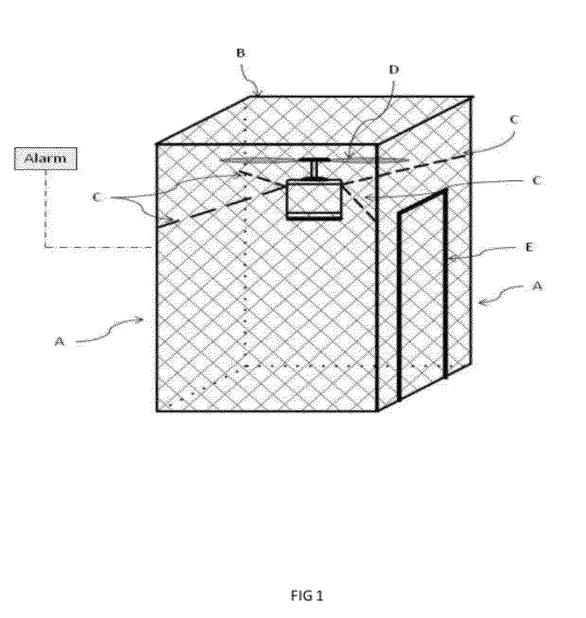

The security cage could be constructed in a rectangular shape from multiple side panels and top panels attached as shown in FIG. 1. The panels can be constructed of a metal or plastic composite material. The panels are constructed to allow the free flow of air through the security cage. Each side panel is connected to the adjacent side panel and a top panel. If the air conditioner/heat pump unit is located in near proximity to a building, the security cage may utilize the building as its fourth wall. The bottom of each side panel is attached to the platform upon which the air conditioner/heat pump rests or is secured to the ground.

The security cage could also be constructed in an oval or circular shape. The bottom of the cage would be attached to the platform upon which the contained air conditioner/heat pump unit rests or secured to the ground. The geometry of the security cage is not limited to the above, but may include any geometry necessary to enclose the equipment in need of protection.

The security cage is equipped with anti-tamper seismic sensors to detect if an attempt is made to breach the security cage. The signal from the sensors is sent to a microprocessor used to trigger an alarm system. The microprocessor can be set to provide for three levels of alert: (1) an audible alarm located in the near proximity of the air conditioner/heat pump unit; (2) an alert signal sent to the security system of the building serviced by the air conditioner/heat pump unit; and/or (3) an alert signal sent to designated cell phone number(s).

Wind-powered turbines are mounted within the security caged positioned to utilize the exhaust from the air conditioner/heat pump condenser fan to generate. The electricity generated from the wind-powered turbine can be used to assist in powering the air conditioner/heat pump unit, the building it services or to feed back into the electrical power grid.

The typical embodiment of the invention for a single air conditioner consists of a security cage constructed from four (4) metal side panel and a top panel. Each panel is fabricated to allow the free movement of air throughout the cage. The panels are attached to each other by welding. Although depending on the size of the cage, the top panel may be hinged on one side with a latch on the opposite to allow for a lock to be attached. This would allow the top panel to be lifted away from the unit for maintenance purposes. One of the side panels would be equipped with a lockable door to allow access to the interior of the cage. The wind generator is supported and attached to the cage with metal support bars welded to the side of the panels. The generator is positioned such that the exhaust from the air conditioner will turn the generator turbine blades. The cage would be equipped with a seismic sensor to detect attempts at vandalism. A signal from the sensor would activate the microprocessor alarm system.

The invention claimed is:

1. An environmentally friendly security cage for enclosing a single or multiple outdoor air conditioner/heat pump condenser units comprising a containment structure; wind-powered electrical generator, and an anti-tampering sensor and alarm system to detect and alert of attempts to breach the security cage.

2. The assembly according to claim 1, where the containment structure is comprised of a number of side and top metallic or organic polymer composite panels arranged in such a shape and connected to each other as to enclose the air conditioner/heat pump condenser unit(s).

3. The assembly according to claim 1, where the containment structure is secured to the support platform of the air conditioner/heat pump condenser unit or to the ground.

4. The assembly according to claim 1, where one or more panels are equipped with doors allowing access to the unit for maintenance purposes; said doors equipped with a locking mechanism.

5. A method to prevent vandalism and theft of valuable components of outdoor air conditioners/heat pump units comprising a security cage, anti-tampering sensor and alarm system.

6. The method according to claim 5, wherein said alarm is an audible alert in the near proximity of the air conditioner/heat pump condenser unit.

7. The method according to claim 5, wherein said alarm is an alert to the security system for the building serviced by the air conditioner/heat pump condenser unit.

8. The method according to claim 5, wherein said alarm is a signal to designated cell phone number(s).

9. A method of generating electricity from air conditioner/heat pump condenser exhaust consisting of wind-powered generator(s) within a security cage for the protection of said air conditioner/heat pump unit.

10. The method according to claim 9, wherein said security cage contains multiple wind-powered generators.
